(19) United States
(12) Patent Application Publication
(10) Pub. No.: US 2015/0112733 A1
(43) Pub. Date: Apr. 23, 2015

(54) In-vehicle insurance applications, Methods and systems for automatically collecting insurance risk related data

(71) Applicant: STATE FARM MUTUAL AUTOMOBILE INSURANCE COMPANY, Bloomington, IL (US)

(72) Inventors: Nicholas R. Baker, Normal, IL (US); Steve J. Balbach, Bloomington, IL (US); Todd Binion, Bloomington, IL (US); Steven Cielocha, Bloomington, IL (US)

(73) Assignee: STATE FARM MUTUAL AUTOMOBILE INSURANCE COMPANY, Bloomington, IL (US)

(21) Appl. No.: 14/061,385

(22) Filed: Oct. 23, 2013

(51) Int. Cl. G06Q 40/08

(52) U.S. Cl. CPC G06Q 40/08
USPC 705/4

(57) ABSTRACT

The applications, methods and systems of the present disclosure provide selective and automatic data collection for insurance risk determination purposes. In particular, an insurance application may be stored in a vehicle computing system memory and may be executed by a vehicle computing system processor to collect and store vehicle operation related data. An in-vehicle computing device may transmit the collected data to a remote server via a wireless communication network. Alternatively, the in-vehicle computing device may transmit the collected data to a mobile telephone via a wireless communication network.

### TECHNICAL FIELD

The present disclosure generally relates to applications, methods and systems for collecting vehicle operation data that may be used for determining insurance risk. More particularly, the present disclosure relates to an insurance application stored in a vehicle computing system memory that may be executed by a vehicle computing system processor to selectively and automatically collect and store data related to operation of a vehicle.

### BACKGROUND

Vehicle insurance rates may be based, at least in part, on data related to driving characteristics of an insured person. For example, vehicle insurance rates may be based on where the insured person lives, where the insured person works, how far an insured person drives to work, how many speeding tickets the insured person has, how many accidents the insured person has, how many previous insurance claims the insured person has, etc. Some of this data may be generated based on information obtained by the insurance provider from the insured person.

Computing systems are becoming common place within vehicles. These vehicle computing systems often collect data from various vehicle sensors, such as global positioning systems, speedometers, odometers, body controllers, etc. Recently, vehicle manufactures have added communications interfaces to the vehicle computer systems, such as universal serial bus (USB) interfaces, wireless communication interfaces, Bluetooth interfaces, WiFi interfaces, cellular telephone interfaces, etc.

It is desirable to store an insurance application within vehicle computing systems that is executed by a vehicle computing system processor to selectively and automatically collect, store and transmit data related to vehicle operations for insurance risk determination purposes.

### SUMMARY

A computerized method for automatically collecting and storing vehicle operation data is provided for determining an insurance risk. The method may include storing, in a memory of a vehicle computing device, an insurance application. The method may also include receiving, at the processor of the vehicle computing device, the vehicle operation data, wherein the vehicle operation data is representative of information related to operation of a vehicle. The method may further include receiving, at the processor of the vehicle computing device, insurance policy data, wherein the insurance policy data is representative of an identification of an insurance policy associated with the vehicle. The method may also include generating, at the processor of the vehicle computing device, insurance risk related data by executing the insurance application on the processor of the vehicle computing device, wherein execution of the insurance application allows user selection of the content of the vehicle operation data and wherein the insurance risk related data is representative of the vehicle operation data and the insurance policy data. The method may further include causing the processor to automatically store the insurance risk related data in the memory coupled to the processor of the vehicle computing device.

In another embodiment, a system for automatically collecting and storing insurance risk related data from a vehicle is provided. The system may include a vehicle operations data collection module stored on a memory that, when executed on a processor, causes the processor to collect vehicle operation data, wherein the vehicle operation data is representative of operation of a vehicle. The system may further include an insurance application module stored on the memory that, when executed on the processor, causes the processor to collect insurance policy data, wherein the insurance policy data is representative of an association between the vehicle and an insurance policy. The system may also include an insurance risk related data generation module stored on the memory that, when executed on a processor, causes the processor to generate insurance risk related data, wherein the insurance risk related data is based, at least in part, on the vehicle operation data and the insurance policy data and wherein the insurance risk related data is representative of an association between the vehicle and the insurance policy. The system may further include an insurance risk related data transmission module stored on the memory that, when executed by the processor, causes the processor to automatically transmit insurance risk related data.

In yet another embodiment, a computer-readable storage medium may include non-transitory computer-readable instructions stored thereon to be executed on a processor of a vehicle computing system for automatically collecting and storing insurance risk related data. The stored instructions may include a vehicle operations data collection module that, when executed on a processor, causes the processor to collect vehicle operation data, wherein the vehicle operation data is representative of operation of a vehicle. The stored instructions may also include an insurance application module that, when executed on the processor, causes the processor to collect insurance policy data, wherein the insurance policy data is representative of an association between the vehicle and an insurance policy. The stored instructions may further include an insurance risk related data generation module that, when executed on a processor, causes the processor to generate insurance risk related data, wherein the insurance risk related data is based, at least in part, on the vehicle operation data and the insurance policy data and wherein the insurance risk related data is representative of an association between the vehicle and the insurance policy. The stored instructions may also include an insurance risk related data transmission module that, when executed by the processor, causes the processor to automatically transmit insurance risk related data.

### BRIEF DESCRIPTION OF THE DRAWINGS

The figures described below depict various aspects of the applications, methods and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIGS. 1A and 1B depict example high level block diagrams for collecting vehicle operation data for insurance rating purposes;

FIGS. 2A-2H and 2J illustrate examples of various vehicles from which data may be collected;

FIGS. 3A and 3B depict high-level block diagrams of example computing systems for collecting insurance risk related data including an in-vehicle computer systems with an insurance application, a mobile device with an insurance application and a remote server with an insurance application;

FIG. 4 depicts a block diagram of an example in-vehicle computing system with an insurance application;

FIGS. 5A and 5B depict flow diagrams of example methods of associating an insured person's vehicle with an insurance application;

FIG. 6 depicts a block diagram of an example mobile telephone with various modules for collecting, storing and transmitting insurance rating related data;

FIGS. 7A and 7B depict flow diagrams of example methods of associating an insured person's mobile telephone with an insurance application and to collect insurance rating related data;

FIG. 8 depicts a block diagram of an example remote server with various modules for collecting and storing insurance rating related data; and

FIGS. 9A and 9B depict flow diagrams of example methods of associating remote server with an insurance application and to collect insurance rating related data.

### DETAILED DESCRIPTION

Insurance rates are often based on various personal characteristics. For example, the cost of automobile insurance may, at least in part, be based on the distance an individual drives to work, where the individual lives, where the individual works, where the individual drives, etc. Generally, this information is provided to the insurance provider by an insurance purchaser at the time an insurance policy application is completed. Insurance providers count on the insurance purchaser to provide new information when changes occur.

The insurance applications of the present disclosure may be stored on a memory of a vehicle computing system and executed by a processor of the vehicle computing system to selectively and automatically collect vehicle operation data that may be used for insurance risk determination. For example, a vehicle may be equipped with a body controller that controls critical vehicle operation tasks, such as acceleration, engine fuel flow, engine air intake and braking functions. The vehicle may also be equipped with an on-board diagnostics (OBD) unit that collects vehicle operation data. The vehicle OBD unit may, for example, collect data representative of a total number of miles a vehicle was driven, a day a vehicle was driven, a time of day a vehicle was driven, a number of turns taken while a vehicle was being driven, a current odometer reading, a vehicle identification number, a seat belt status, a location of the vehicle, etc. A vehicle insurance application may be stored on a memory of a vehicle computing system and executed on a processor within the vehicle computing system that may selectively and automatically collect vehicle operation data from the vehicle an OBD unit and/or other vehicle systems and to interpret and transmit the collected vehicle operation data. The insurance application within the vehicle may work in conjunction with a mobile telephone insurance application to selectively and automatically collect, interpret, and transmit the vehicle operation data. A remote server insurance application may work in conjunction with the vehicle insurance application and/or the mobile telephone insurance application to selectively and automatically collect, interpret, and transmit the vehicle operation data.

The vehicle insurance application may be configured to selectively and automatically collect, for example, vehicle location data, vehicle elevation data, vehicle heading direction data, vehicle odometer data, vehicle speed data, vehicle G-force magnitude and direction data, vehicle engine speed data, vehicle fuel level data, vehicle fuel consumption data, vehicle identification number (VIN) data, external temperature data, vehicle park-reverse-neutral-drive lever (PRNDL) status data, vehicle tire pressure data, calendar date data, time of day data, vehicle seat belt status data, vehicle brake pedal switch status data, etc. The in-vehicle insurance application may further collect emergency assistance related data, such as vehicle airbag status data, vehicle body controller information (e.g., ignition status, etc.) data, vehicle computing system status (e.g., signal strength, battery strength, etc.) data, vehicle emergency event status (e.g., air bag status) data, vehicle instrument cluster modes (e.g. power modes, etc.) data, etc.

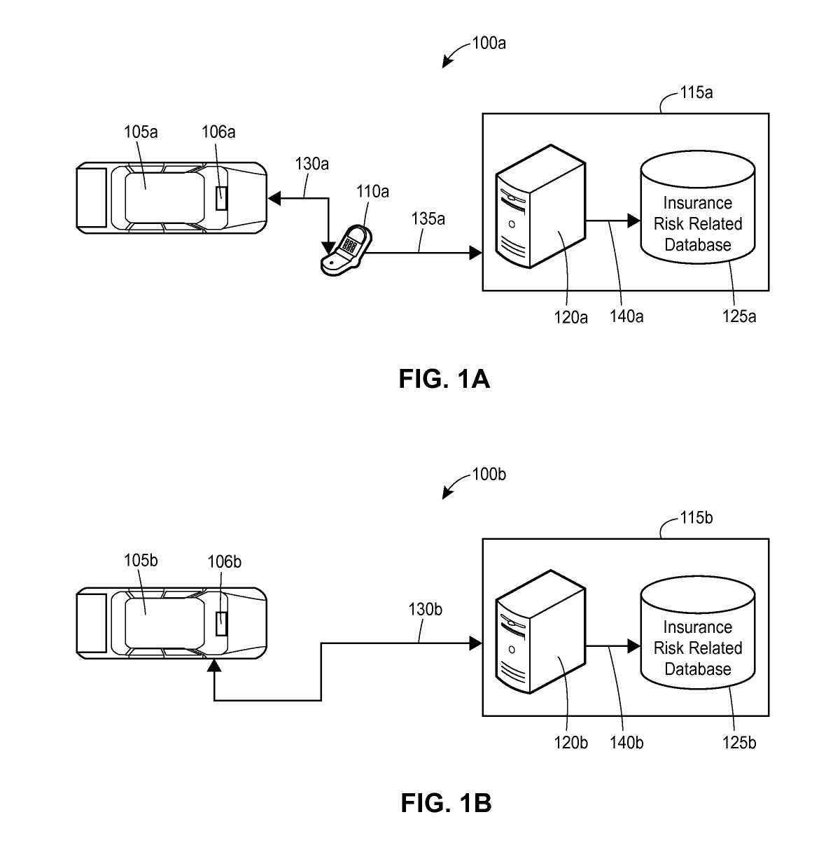

With reference to FIGS. 1A and 1B, insurance risk related data collection systems 100a, 100b are illustrated. As depicted in FIG. 1A, the insurance risk related data collection system 100a may include a vehicle 105a having a vehicle computer system 106a with an insurance application. The vehicle computer system 106a is described in detail herein along with a vehicle insurance application that may be stored on a memory of the vehicle computer system 106a and that may be executed on a processor of the vehicle computer system 106a to selectively and automatically collect, store and transmit vehicle operation related data. The insurance risk related data collection system 100a may further include a mobile telephone 110a with an insurance application. As described in detail herein, the mobile telephone 110a may include a mobile telephone application that may be stored on a memory of the mobile telephone 110a and that may be executed by a processor of the mobile telephone 110a to selectively and automatically collect, store and transmit insurance risk related data. The mobile telephone 110a may be communicatively coupled to the vehicle computer system 106a via a first wireless communication network 130a, such as a first cellular telephone communications network. The insurance risk related data collection system 110a may also include a remote computing system 115a with an insurance application. The remote computing system 115a may include a remote server 120a and an insurance risk related database 125a. As depicted in FIG. 1A, the remote server 120a may be communicatively coupled to the mobile telephone 110a via a second wireless communication network 135a, such as a second cellular telephone communications network. It should be understood that the first wireless communications network and the second wireless communications network, may be, at least in part, common to one another. The insurance risk related database 125a may be communicatively coupled to the remote server 120a via a network connection 140a. As described in detail herein, the insurance risk related database 125a may store insurance risk related data that is representative of vehicle operation information and insurance policy information.

As depicted in FIG. 1B, the insurance risk related data collection system 100b may include a vehicle 105b having a vehicle computer system 106b with an insurance application. The vehicle computer system 106b is described in detail herein along with a vehicle insurance application that may be stored on a memory of the vehicle computer system 106b and that may be executed on a processor of the vehicle computer system 106b to selectively collect, store and transmit vehicle operation related data. The insurance risk related data collection system 110b may also include a remote computing system 115b. The remote computing system 115b may include a remote server 120b and an insurance risk related database 125b. As depicted in FIG. 1B, the remote server 120b may be communicatively coupled to the vehicle computer system 106b via a wireless communication network 130b, such as a cellular telephone communications network. The insurance risk related database 125b may be communicatively coupled to the remote server 120b via a network connection 140b. As described in detail herein, the insurance risk related database 125b may store insurance risk related data that is representative of vehicle operation information and insurance policy information.

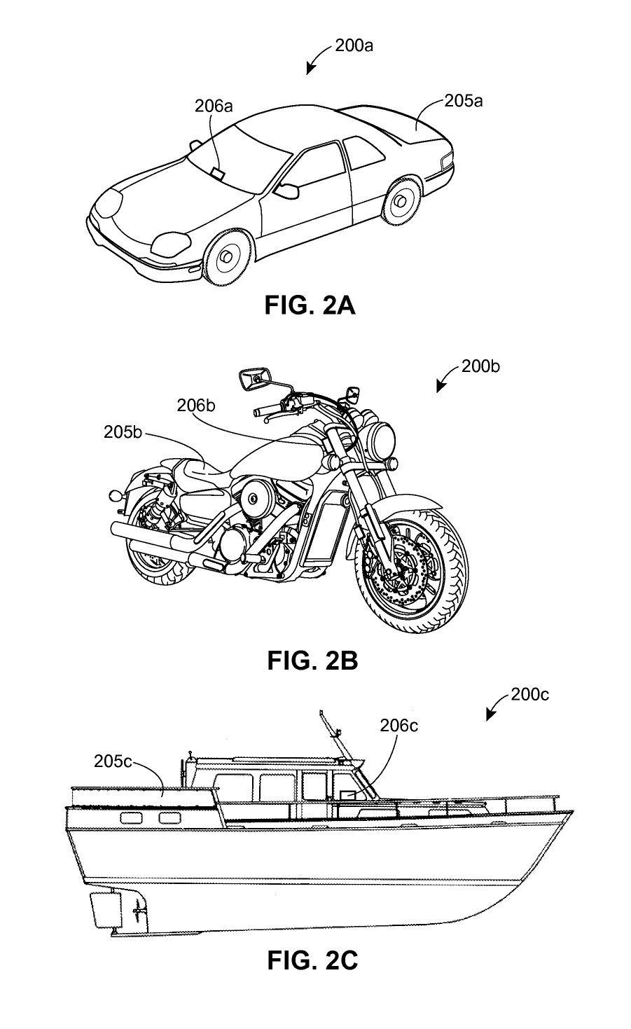

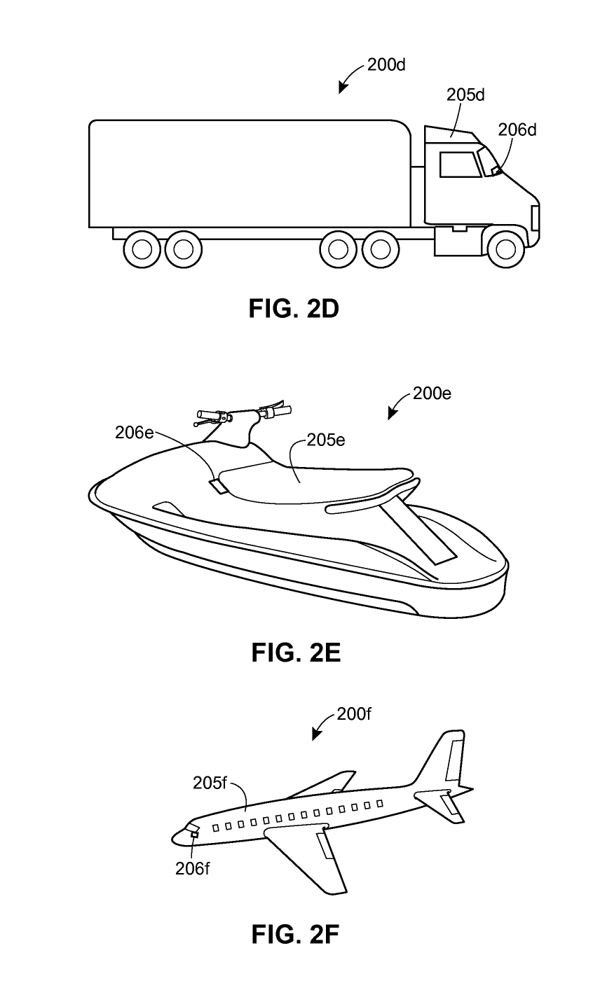

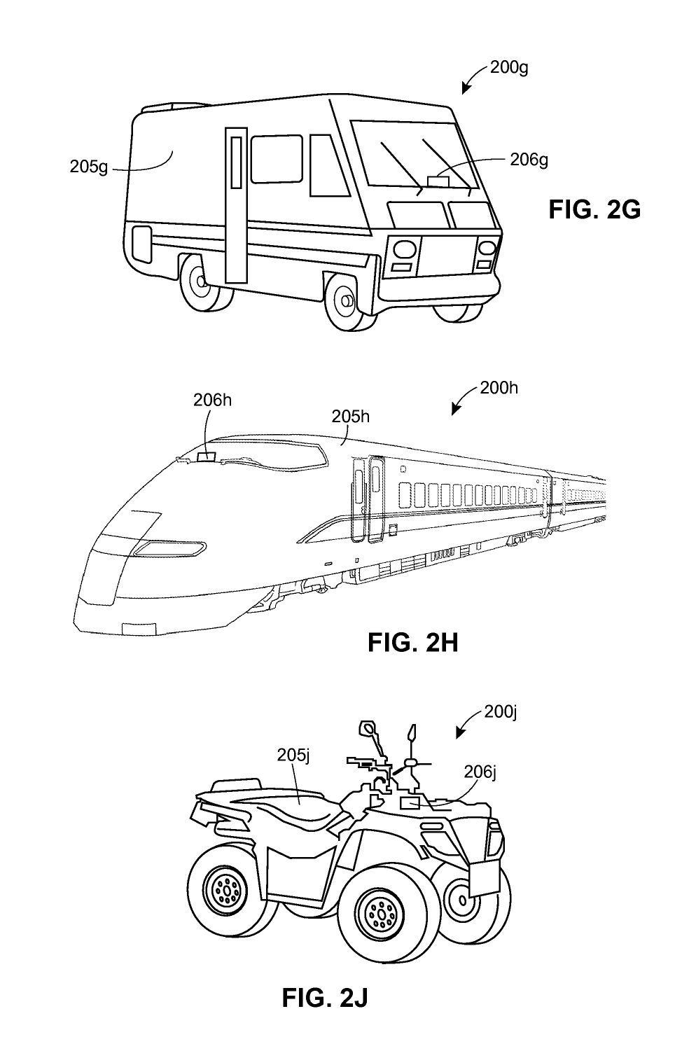

Turning to FIGS. 2A-2H and 2J, various embodiments of insurance risk related data collection systems 200a-200h and 200j are depicted. The insurance risk related data collection systems 200a-200h and 200j may be used within the insurance risk related data collection systems 100a, 100b. As depicted in FIG. 2A, an insurance risk related data collection system 200a may include a vehicle computer system having an insurance application 206a within a car 205a. As depicted in FIG. 2B, an insurance risk related data collection system 200b may include a vehicle computer system having an insurance application 206b on a motorcycle 205b. As depicted in FIG. 2C, an insurance risk related data collection system 200c may include a vehicle computer system having an insurance application 206c within a boat 205c. As depicted in FIG. 2D, an insurance risk related data collection system 200d may include a vehicle computer system having an insurance application 206d within a semi-truck 205e. As depicted in FIG. 2E, an insurance risk related data collection system 200e may include a vehicle computer system having an insurance application 206e within a jet ski 205e. As depicted in FIG. 2F, an insurance risk related data collection system 200f may include a vehicle computer system having an insurance application 206f within an airplane 205f. As depicted in FIG. 2G, an insurance risk related data collection system 200g may include a vehicle computer system having an insurance application 206g within a recreational vehicle 205g. As depicted in FIG. 2H, an insurance risk related data collection system 200h may include a vehicle computer system having an insurance application 206h within a train 205h. As depicted in FIG. 2J, an insurance risk related data collection system 200j may include a vehicle computer system having an insurance application 206j on an all-terrain vehicle 205j. It should be understood that an insurance risk related data collection system 200a may be attached to any vehicle 205a. As described elsewhere herein, any given insurance risk related data collection system 200a may be associated with an insured person's mobile telephone 110a such that the mobile telephone 110a may automatically collect vehicle operation data related to the vehicle 205a-205h and 205j.

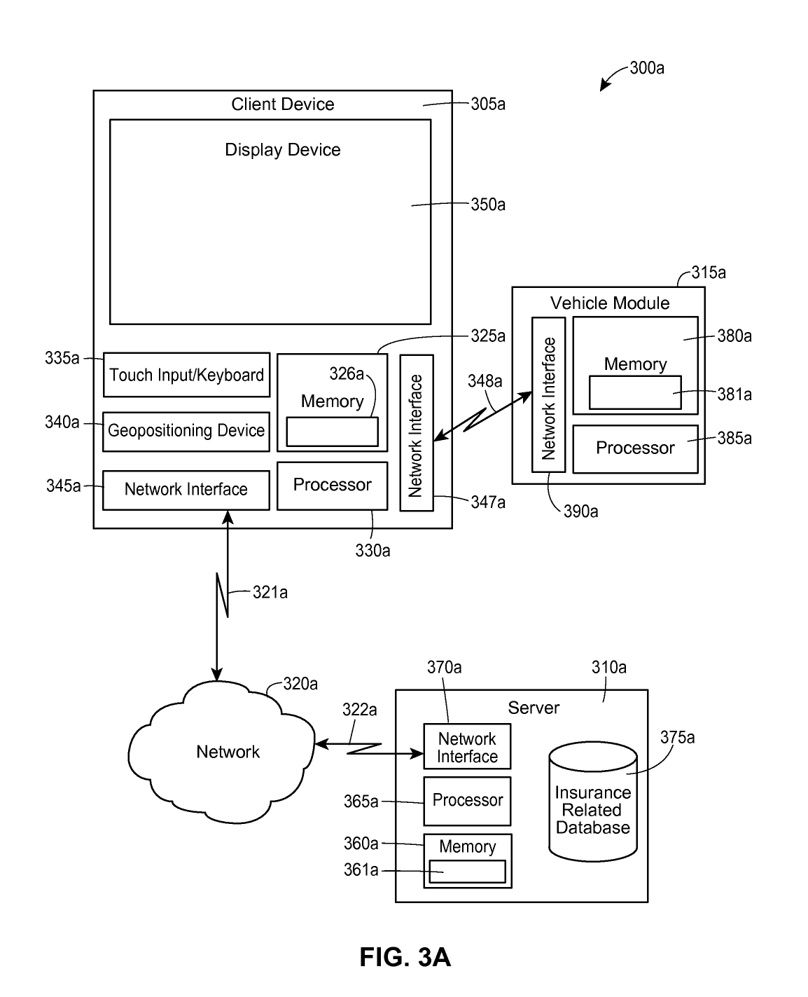

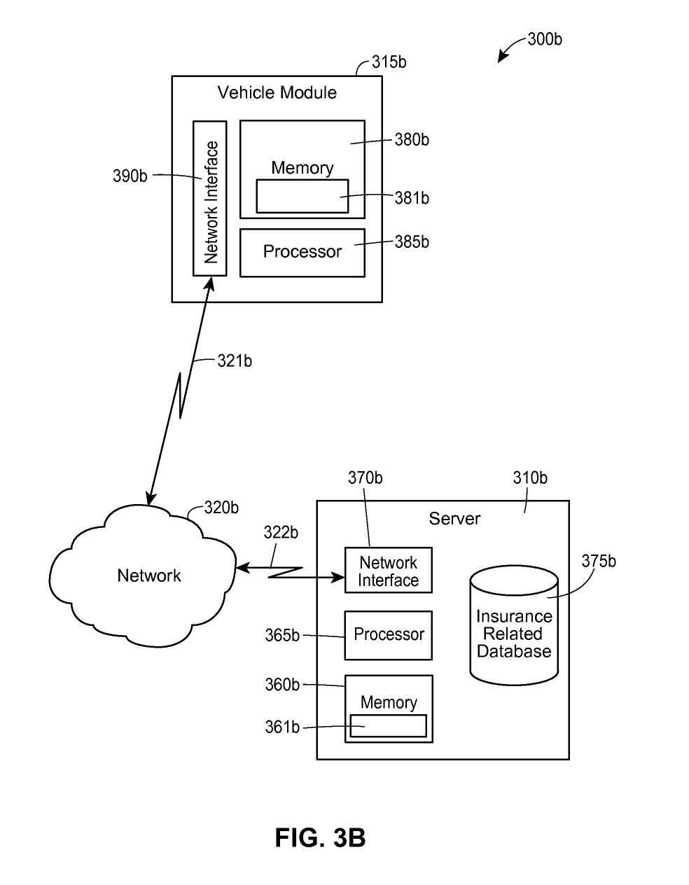

The details associated with insurance risk related data collection systems 300a, 300b are now described beginning with reference to FIGS. 3A and 3B, respectively. FIG. 3A depicts a high-level block diagram of an insurance risk related data collection system 300a that implements communications between a vehicle module 315a (e.g., vehicle computing system with insurance application 106a of FIG. 1A), a client device 305A (e.g., a mobile telephone with insurance application 110a of FIG. 1A) and a remote computing device 310a (e.g., remote computing device with insurance application 115a of FIG. 1A) to provide data to an insurance related database 375a (e.g., insurance related database 125a of FIG. 1A). The client device 305a may be communicatively coupled to the vehicle module 315a via a first wireless communication network 348a and communicatively coupled to the remote computing device 310a via a second wireless communication network 320a. For example, the first and second wireless communications networks 348a, 320a may be defined by a wireless cellular telephone communications network.

For clarity, only one vehicle module 315a and only one client device 305a are depicted in FIG. 3A. While FIG. 3A depicts only one vehicle module 315a and only one client device 305a, it should be understood that any number of vehicle modules 315a and client devices 305a may be supported and that each client device 305a may be any appropriate computing device, such as a mobile telephone, a personal data assistant, a tablet or a lap-top computer. The vehicle module 315a may include a memory 380a and a processor 385a for storing and executing, respectively, a module 381a. The module 381a, stored in the memory 380a as a set of computer-readable instructions, may be related to a vehicle operations data collecting application that, when executed on the processor 385a, causes the processor 385a to collect vehicle operation data and to store the vehicle operation data in the memory 380a. Execution of the module 381a may further cause the processor 385a to associate the vehicle operation data with a vehicle 105a, with an insurance policy and to interpret the vehicle operation data to determine insurance risk related data, such as associating a day and/or time with specific vehicle operation data. Execution of the module 381a may further cause the processor 385a to communicate with the processor 330a of the client device 305a via the network interface 390a, the first wireless communication network 348a and the network interface 347a.

The client device 305a may include a memory 325a and a processor 330a for storing and executing, respectively, a module 336a. The module 336a, stored in the memory 325a as a set of computer-readable instructions, may be related to an insurance risk related data collecting application that, when executed on a processor 330a, causes insurance risk related data to be retrieved from a vehicle module 315a and to be stored in the memory 325a. As described in detail herein, the module 336a may facilitate interaction between the client device 305a, the vehicle module 315a and the remote computing device 310a. The processor 330a, further executing the module 336a, may facilitate communications between the computing device 310a and the client device 305a via a network interface 345a, a client device network connection 321a and the network 320a.

The client device 305a may include a display device 350a which may be any type of electronic display device such as a liquid crystal display (LCD), a light emitting diode (LED) display, a plasma display, a cathode ray tube (CRT) display, or any other type of known or suitable electronic display. The display device 350a may exhibit a display which depicts a user interface for configuring the client device 305a to communicate with the vehicle module 315a via the network interface 347a, the wireless link 348a and the vehicle module 315a network interface 390a. The client device 305a may include a user input device 335a, such as a touch input/keyboard/pointing device (e.g., a mouse) that provides a mechanism for a user of the client device 305a to launch a client device insurance application and, for example, to select what vehicle operation related data to collect. The user input device 335a may be configured as an integral part of a display device 350a, such as a touch screen display device. The network interface 345a may be configured to facilitate communications between the client device 305a and the remote computing device 310a via any wireless communication network 320a, including for example a wireless LAN, MAN or WAN, WiFi, the Internet, or any combination thereof. Moreover, the client device 305 may be communicatively connected to the remote computing device 310a via any suitable communication system, such as via any publicly available or privately owned communication network, including those that use wireless communication structures, such as wireless communication networks, including for example, wireless LANs and WANs, satellite and cellular telephone communication systems, etc. The client device 305a may cause insurance risk related data to be transmitted to and stored in a remote server 310a memory 360a and/or a remote insurance related database 375a.

The computing device 310a may include a memory 360a and a processor 365a for storing and executing, respectively, a module 361a. The module 361a, stored in the memory 360a as a set of computer-readable instructions, facilitates applications related to collecting insurance risk related data. The module 361a may also facilitate communications between the computing device 310a and the client device 305a via a network interface 370a, a remote computing device network connection 322a and the network 320a and other functions and instructions.

The computing device 310a may be communicatively coupled to an insurance related database 375a. While the insurance related database 375a is shown in FIG. 3A as being communicatively coupled to the remote computing device 310a, it should be understood that the insurance related database 375a may be located within separate remote servers (or any other suitable computing devices) communicatively coupled to the remote computing device 310a. Optionally, portions of insurance related database 375a may be associated with memory modules that are separate from one another, such as a memory 325a of the client device 305a.

FIG. 3B depicts a high-level block diagram of an insurance risk related data collection system 300b that implements communications between a vehicle module 315b (e.g., vehicle computing system with insurance application 106b of FIG. 1B) and a remote computing device 310b (e.g., remote computing device 115b of FIG. 1B) to provide data to an insurance related database 375b (e.g., insurance related database 125b of FIG. 1B).

For clarity, only one vehicle module 315b is depicted in FIG. 3B. While FIG. 3B depicts only one vehicle module 315b, it should be understood that any number of vehicle modules 315b may be supported. The vehicle module 315b may include a memory 380b and a processor 385b for storing and executing, respectively, a module 381b. The module 381b, stored in the memory 380b as a set of computer-readable instructions, may be related to a vehicle operations data collecting application that, when executed on the processor 385b, causes vehicle operation data to be stored in the memory 380b. Execution of the module 381b may further cause the processor 385b to associate the vehicle operation data with a vehicle 105b, with an insurance policy and to interpret the vehicle operation data to determine insurance risk related data, such as associating a day and/or time with specific vehicle operation data. Execution of the module 381b may further cause the processor 385b to communicate with the processor 365b of the remote computing device 310b via the network interface 390b, the wireless communication network 320b and the network interface 370b.

The network interface 390b may be configured to facilitate communications between the vehicle module 315b and the remote computing device 310b via any hardwired or wireless communication network 320b, including for example a hardwired Ethernet connection or a wireless LAN, MAN or WAN, WiFi, the Internet, or any combination thereof. Moreover, the client device 305 may be communicatively connected to the remote computing device 310a via any suitable communication system, such as via any publicly available or privately owned communication network, including those that use wireless communication structures, such as wireless communication networks, including for example, wireless LANs and WANs, satellite and cellular telephone communication systems, etc. The vehicle module 315b may cause insurance risk related data to be stored in a remote server 310b memory 360b and/or a remote insurance related database 375b.

The computing device 310b may include a memory 360b and a processor 365b for storing and executing, respectively, a module 361b. The module 361b, stored in the memory 360b as a set of computer-readable instructions, facilitates applications related to collecting insurance risk related data. The module 361b may also facilitate communications between the computing device 310b and the vehicle module 315b via a network interface 370b, a remote computing device network connection 322b and the network 320b and other functions and instructions.

The computing device 310b may be communicatively coupled to an insurance related database 375b. While the insurance related database 375b is shown in FIG. 3B as being communicatively coupled to the remote computing device 310b, it should be understood that the insurance related database 375b may be located within separate remote servers (or any other suitable computing devices) communicatively coupled to the remote computing device 310b. Optionally, portions of insurance related database 375b may be associated with memory modules that are separate from one another, such as a memory 325b of the client device 305b.

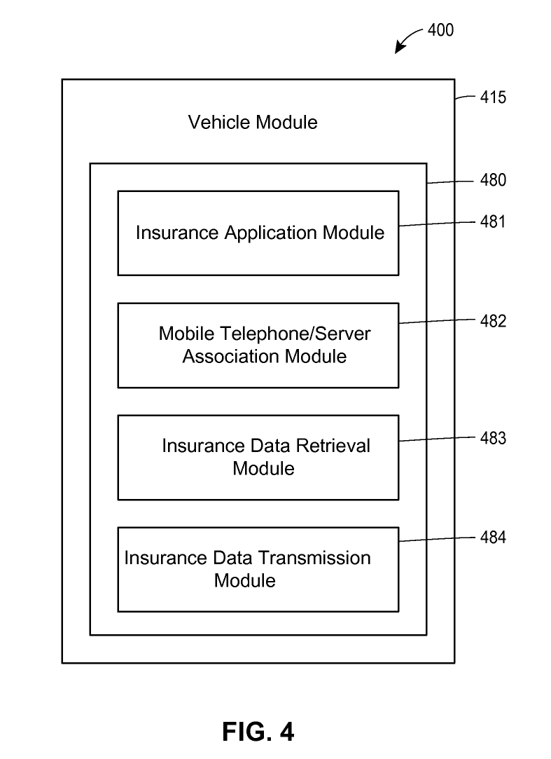

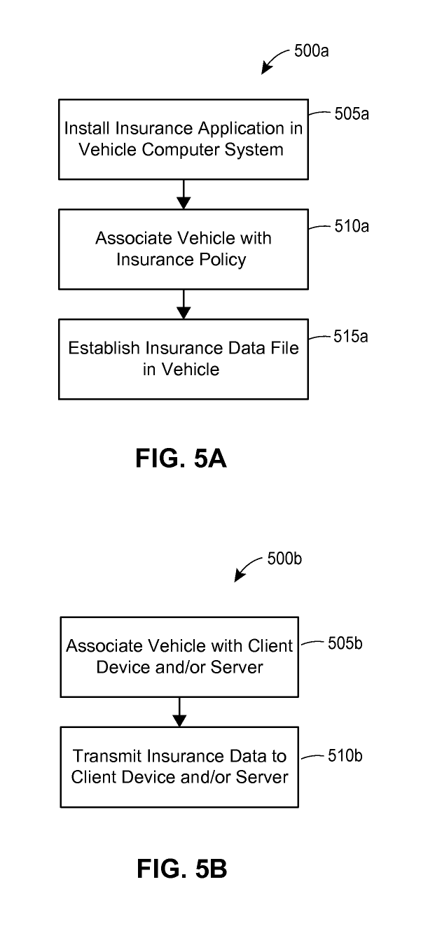

Turning to FIGS. 4, 5A and 5B, a vehicle module 415 of an insurance risk related data collection system 400 is depicted along with a method of establishing an insurance risk related data file in the vehicle module 500a and a method of transmitting insurance risk related data to a client device/remote server 500b. The vehicle module 415 may be similar to the vehicle computing system with insurance application 106a of FIG. 1A or the vehicle computing system with insurance application 106b of FIG. 1B. The methods 500a, 500b may be implemented by executing the modules 481-484 on a processor (e.g., processor 385a, 385b). In any event, the vehicle module 415 may include an insurance application module 481, a mobile telephone/server association module 482, an insurance data retrieval module 483 and an insurance data transmission module 484 stored in a memory 480. The processor 385a, 385b may execute the insurance application module 481 to, for example, cause the processor 385a, 385b to receive user inputs and associate the vehicle module 415 with a vehicle (e.g., vehicle 105a, 105b), associate the vehicle 105a with an insurance policy (block 505a) and to selectively determine the content of vehicle operation data (block 515a) based on the user inputs. Alternatively, execution of the insurance application module 481 may automatically associate the vehicle module 415 with a vehicle 105a, 105b with an insurance policy (block 510a) and to automatically determine the content of vehicle operation data (block 515a). For example, the vehicle module 415 may be pre-configured to automatically associate the vehicle module 415 with a vehicle 105a, 105b with an insurance policy and to automatically determine the content of vehicle operation data when an insurance application 481 is stored in a vehicle computing device memory 380a (block 505a).

The processor 385a, 385b may execute the mobile telephone/server association module 482 to, for example, cause the processor 385a, 385b to receive user inputs and associate the vehicle module 415 with a client device (e.g., mobile telephone 110a) and/or a remote computing device (e.g., remote server 120a, 120b) based on the user inputs (block 505b). Alternatively, execution of the mobile telephone/server association module 482 may automatically associate the vehicle module 415 with a client device 110a and/or a remote computing device 120a, 120b (block 505b). For example, the vehicle module 415 may be pre-configured to automatically associate the vehicle module 415 with a client device 110a and/or a remote computing device 120a, 120b when an insurance application 481 is stored in a vehicle computing device memory 380a (block 505a).

The processor 385a, 385b may execute the insurance data retrieval module 483 to, for example, cause the processor 385a, 385b to retrieve vehicle operation data from a vehicle system, such as a vehicle on-board diagnostics (OBD) unit, a body controller, a vehicle global positioning device, a vehicle calendar, a vehicle clock, a combination thereof, a sub-combination thereof, etc. (block 515a). The processor 385a, 385b may execute the insurance data transmission module 484 to, for example, cause the processor 385a, 385b to transmit insurance risk related data to a mobile telephone 110a and/or a remote computing device 120a, 120b (block 510b).

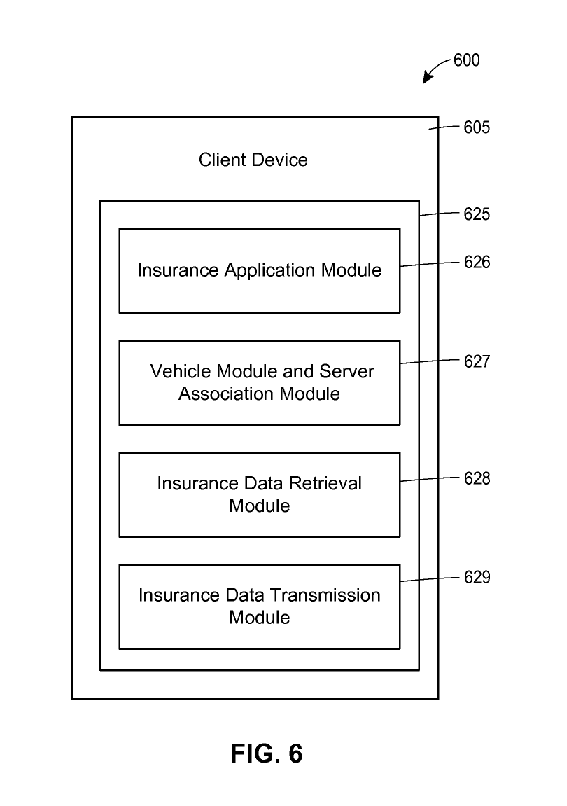

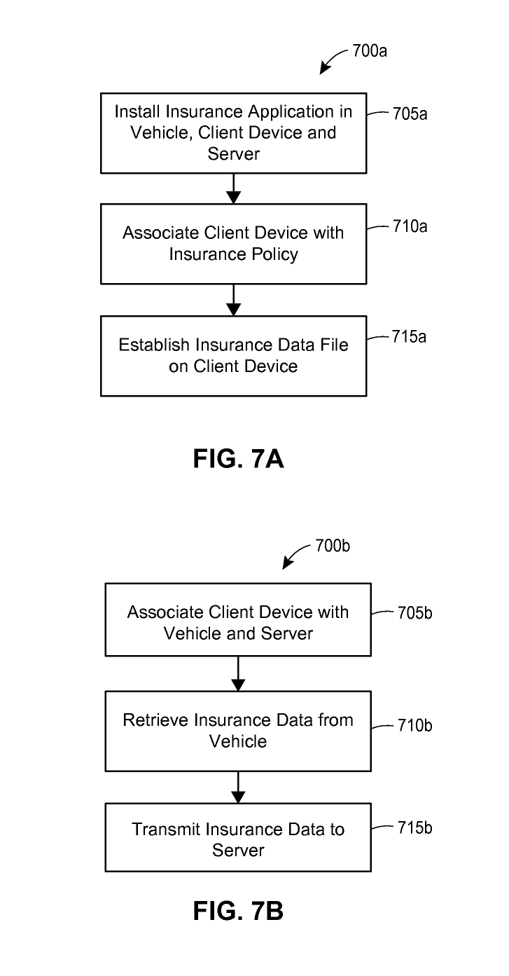

Turning to FIGS. 6, 7A and 7B, a client device 605 of an insurance risk related data collection system 600 is depicted along with a method of establishing an insurance risk related data file on the client device 700a and a method of transmitting insurance risk related data to a server 700b. The client device 705 may be similar to the mobile telephone with insurance application 110a of FIG. 1A. The methods 500a, 500b may be implemented by executing the modules 626-629 on a processor (e.g., processor 330a). In any event, the client device 605 may include an insurance application module 626, a vehicle module and server association module 627, an insurance data retrieval module 628 and an insurance data transmission module 629 stored in a memory 625. The processor 330a may execute the insurance application module 626 to, for example, cause the processor 330a to receive user inputs and associate the client device 605 with a vehicle module 415 (block 705a), associate the client device 605 with a remote server 810 (block 705a), associate the client device 605 with an insurance policy (block 710a) and to selectively determine the content of an insurance data file on the client device 605 (block 715a) based on the user inputs. Alternatively, the processor 330a may execute the vehicle module and server association module 628 to, for example, automatically associate the client device 605 with a vehicle module 415 (block 705a), with a remote server 810 (block 705a) and with an insurance policy (block 710a) and to automatically determine the content of vehicle operation data (block 715a). For example, the client device 605 may be pre-configured to automatically associate the client device 605 with a vehicle module 415 (block 705b), with a remote server 810 (block 705b) and with an insurance policy (block 710a) and to automatically determine the content of vehicle operation data when an insurance application 626 is stored in a client device memory 625 (block 705a).

The processor 330a may execute the insurance data retrieval module 628 to, for example, retrieve insurance risk related data from a vehicle module 415 (block 710b). For example, the processor 330a may cause the client device 605 to retrieve insurance risk related data from a vehicle module 415 (block 710b) via a wireless cellular telephone network, a Bluetooth network, a WiFi network, etc. The processor 330a may execute the insurance data transmission module 629 to, for example, transmit insurance risk related data to a remote server 810 (block 715b). For example, the processor 330a may cause the client device 605 to transmit insurance risk related data to a remote server 810 (block 715b) via a wireless cellular telephone network, a Bluetooth network, a WiFi network, etc.

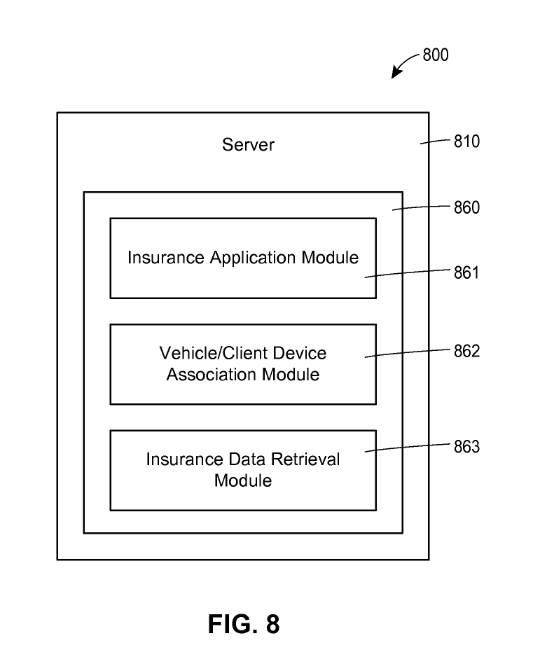

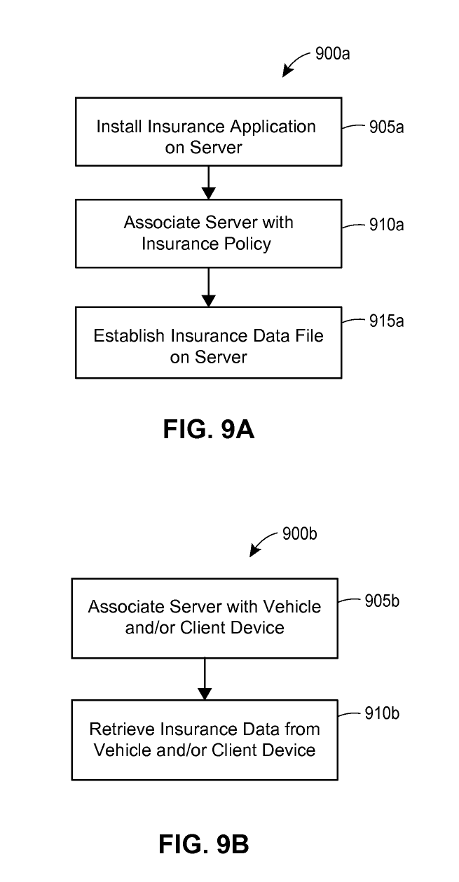

Turning to FIGS. 8, 9A and 9B, a remote server 810 of an insurance risk related data collection system 800 is depicted along with a method of establishing an insurance risk related data file on the server 900a and a method of retrieving insurance risk related data from a vehicle module/client device 900b. The remote server 810 may be similar to the remote server with insurance application 120a, 120b of FIGS. 1A and 1B, respectively. The methods 900a, 900b may be implemented by executing the modules 861-863 on a processor (e.g., processor 365a, 365b). In any event, the remote server 810 may include an insurance application module 861, a vehicle/client device association module 862 and an insurance data retrieval module 863 stored on a memory 860. The processor 365a, 365b may execute the insurance application module 861 to, for example, cause the processor 365a, 365b to receive user inputs and associate the remote server 610 with a vehicle module 615 (block 905a), associate the remote server 615 with a client device (block 905a), associate the remote server 610 with an insurance policy (block 910a) and to selectively determine the content of an insurance data file on the remote server 610 (block 915a) based on the user inputs. Alternatively, the processor 365a, 365b may execute the vehicle/client device association module 862 to, for example, automatically associate the remote server 610 with a vehicle module 615 (block 905b), with a client device (block 905b) and with an insurance policy (block 910a) and to automatically determine the content of vehicle operation data (block 915a). For example, the remote server 810 may be pre-configured to automatically associate the remote server 810 with a vehicle module 415 (block 905b), with a client device 605 (block 905b) and with an insurance policy (block 910a) and to automatically determine the content of vehicle operation data when an insurance application 861 is stored in a remote server memory 810 (block 905a).

The processor 330a may execute the insurance data retrieval module 628 to, for example, retrieve insurance risk related data from a vehicle module 615 (block 710b). For example, the processor 330a may cause the client device 605 to retrieve insurance risk related data from a vehicle module 615 (block 710b) via a wireless cellular telephone network, a Bluetooth network, a WiFi network, etc.

This detailed description is to be construed as exemplary only and does not describe every possible embodiment, as describing every possible embodiment would be impractical, if not impossible. One could implement numerous alternate embodiments, using either current technology or technology developed after the filing date of this application.

1. A computerized method for automatically collecting and storing vehicle operation data for determining an insurance risk associated with an insured individual, the method comprising:
storing, in a memory of a vehicle computing device, an insurance application;
receiving, at a processor of the vehicle computing device, from vehicle sensors, the vehicle operation data, wherein the vehicle operation data is representative of information related to operation of a vehicle;
receiving, at the processor of the vehicle computing device, insurance policy data, wherein the insurance policy data is representative of an identification of an insurance policy associated with the vehicle;
generating, at the processor of the vehicle computing device, insurance risk related data by executing the insurance application on the processor of the vehicle computing device, wherein execution of the insurance application allows selection of content of the vehicle operation data by the insured individual, and wherein the insurance risk related data is based, at least in part, on the content of the vehicle operation data selected by the insured individual and the insurance policy data; and
causing the processor to automatically store the insurance risk related data in the memory coupled to the processor of the vehicle computing device.

2. The method of claim 1, further comprising:
causing the processor to automatically transmit the insurance risk related data to a remote server via a wireless communication network.

3. The method of claim 1, further comprising:
causing the processor to automatically transmit the insurance risk related data to a client computing device via a wireless communication network.

4. The method of claim 3, further comprising:
causing the client device to automatically transmit the insurance risk related data to a remote server via a wireless communication network.

5. The method of claim 1, wherein the vehicle operation data is representative of at least one of: a vehicle location, a vehicle elevation, a vehicle direction heading, a vehicle odometer value, vehicle speed value, G-force value and direction, a vehicle engine speed value, a vehicle fuel level value, a vehicle fuel consumption value, a vehicle identification number (VIN), an external temperature value, a park-reverse-neutral-drive lever (PRNDL) status, a tire pressure value, a calendar date, a time, a vehicle seat belt status, a vehicle brake pedal switch status, vehicle emergency assistance related information, a vehicle airbag status, vehicle body controller information, a vehicle ignition status, a vehicle communication device signal strength value, a vehicle battery charge value, a vehicle emergency event status, a vehicle instrument cluster mode value, or a vehicle power mode.

6. The method of claim 5, further comprising:
receiving, at the processor of the vehicle computing device, a user input representative of an indication of the desired content of the vehicle operation data.

7. The method of claim 1, further comprising:
receiving, at the processor of the vehicle computing device, a user input representative of an indication whether the insurance risk related data is to be transmitted to a mobile telephone or a remote server.

8. A system for automatically collecting and storing insurance risk related data from a vehicle, the system comprising:
a vehicle operations data collection module stored on a memory that, when executed on a processor, causes the processor to collect vehicle operation data from vehicle sensors, wherein the vehicle operation data is representative of operation of a vehicle by an insured individual;
an insurance application module stored on the memory that, when executed on the processor, causes the processor to collect insurance policy data, wherein execution of the insurance application allows selection of content of the vehicle operation data by the insured individual, and wherein the insurance policy data is representative of an association between the vehicle and an insurance policy;
an insurance risk related data generation module stored on the memory that, when executed on a processor, causes the processor to generate insurance risk related data, wherein the insurance risk related data is based, at least in part, on the content of the vehicle operation data selected by the insured individual and the insurance policy data, and wherein the insurance risk related data is representative of an association between the vehicle and the insurance policy; and
an insurance risk related data transmission module stored on the memory that, when executed by the processor, causes the processor to automatically transmit insurance risk related data.

9. The system of claim 8, further comprising:
an insurance application configuration module stored on the memory that, when executed by the processor, causes the processor to receive user inputs, wherein the user inputs are indicative of the content of the vehicle operation data and a remote device to which the processor automatically transmits the insurance risk related data is transmitted.

10. The system of claim 8, wherein the processor automatically transmits the insurance risk related data to at least one of: a mobile telephone and a remote server.

11. The system of claim 8, wherein the vehicle operation data is representative of at least one of: a vehicle location, a vehicle elevation, a vehicle direction heading, a vehicle odometer value, vehicle speed value, G-force value and direction, a vehicle engine speed value, a vehicle fuel level value, a vehicle fuel consumption value, a vehicle identification number (VIN), an external temperature value, a park-reverse-neutral-drive lever (PRNDL) status, a tire pressure value, a calendar date, a time, a vehicle seat belt status, a vehicle brake pedal switch status, vehicle emergency assistance related information, a vehicle airbag status, vehicle body controller information, a vehicle ignition status, a vehicle communication device signal strength value, a vehicle battery charge value, a vehicle emergency event status, a vehicle instrument cluster mode value, or a vehicle power mode.

12. The system of claim 11, wherein the insurance policy data is representative of at least one of: an insurance policy number; an insured vehicle identification; or an identity of an insured individual.

13. The system of claim 8, wherein the processor, executing the insurance risk related data generation module, generates the insurance risk related data based, at least in part, on a number of miles driven, a day and time that the vehicle was driven, a type of vehicle driven, or an age of the driver.

14. The system of claim 8, wherein the processor, executing the vehicle operation data collection module, collects vehicle operation data from an on-board diagnostics device.

15. A computer-readable storage medium comprising non-transitory computer-readable instructions stored thereon and to be executed on a processor of a vehicle computing system for automatically collecting and storing insurance risk related data associated with an insured individual, the stored instructions comprising:
a vehicle operations data collection module that, when executed on a processor, causes the processor to collect vehicle operation data from vehicle sensors, wherein the vehicle operation data is representative of operation of a vehicle;
an insurance application module that, when executed on the processor, causes the processor to collect insurance policy data, wherein execution of the insurance application allows selection of content of the vehicle operation data by the insured individual, and wherein the insurance policy data is representative of an association between the vehicle and an insurance policy;
an insurance risk related data generation module that, when executed on a processor, causes the processor to generate insurance risk related data, wherein the insurance risk related data is based, at least in part, on the content of the vehicle operation data selected by the insured individual and the insurance policy data, and wherein the insurance risk related data is representative of an association between the vehicle and the insurance policy; and
an insurance risk related data transmission module that, when executed by the processor, causes the processor to automatically transmit insurance risk related data.

16. The computer-readable storage medium of claim 15, wherein the instructions further comprise:
an insurance application configuration module stored on the memory that, when executed by the processor, causes the processor to receive user inputs, wherein the user inputs are indicative of the content of the vehicle operation data and a remote device to which the processor automatically transmits the insurance risk related data is transmitted.

17. The computer-readable storage medium of claim 15, wherein the instructions further comprise:
a client device insurance risk related data receiving and transmission module that, when executed by a processor of a client device, causes the processor of the client device to automatically receive insurance risk related data from a processor of a vehicle computing device and to automatically transmit the insurance risk related data to a remote server.

18. The computer-readable storage medium of claim 15, wherein the instructions further comprise:
an on-board diagnostics device interface module that, when executed by the processor, causes the processor to collect vehicle operation data from a vehicle on-board diagnostics device; and
a body controller interface module that, when executed by the processor, causes the processor to collect vehicle operation data from a vehicle body controller.

19. The computer-readable storage medium of claim 15, wherein the processor, executing the insurance risk related data generation module, generates the insurance risk related data based, at least in part, on a number of miles driven, a day and time that the vehicle was driven, a type of vehicle driven, or an age of the driver.

20. The computer-readable storage medium of claim 19, wherein the processor, executing the insurance risk related data generation module, associates at least a portion of the vehicle operation data with a day and a time.
